(19) United States
(12) Patent Application Publication
(10) Pub. No.: US 2026/0246966 A1
(43) Pub. Date: Aug. 20, 2026

(54) CROSS-COMPONENT MODEL SIMPLIFICATIONS

(71) Applicant: InterDigital CE Patent Holdings, SAS, Paris (FR)

(72) Inventors: Philippe BORDES, LAILLE (FR); Karam NASER, mouazé (FR); Fabrice URBAN, Thorigne Fouillard (FR); Franck GALPIN, Thorigne-Fouillard (FR)

(21) Appl. No.: 19/160,707

(22) PCT Filed: Feb. 16, 2024
(86) PCT No.: PCT/EP2024/053954

§ 371 Date: Aug. 28, 2025

(30) Foreign Application Priority Data
Mar. 2, 2023 (EP) 23305278.6

(51) Int. Cl. H04N 19/593; H04N 19/105; H04N 19/132; H04N 19/17; H04N 19/184; H04N 19/186; H04N 19/42; H04N 19/463

(52) U.S. Cl. CPC H04N 19/593; H04N 19/105; H04N 19/132; H04N 19/17; H04N 19/184; H04N 19/186; H04N 19/42; H04N 19/463

(57) ABSTRACT

Apparatuses and methods are disclosed including techniques for encoding and decoding video data. The disclosed techniques include obtaining video data, including data representing a video data region, and then computing models used for cross-component based prediction of chroma samples from the video data region. The computing of models includes accumulating concurrently data of multiple models using a single loop through reference samples selected from the video data. The accumulated data of the models are generated based on the reference samples according to their classification into respective classes. The models are then applied using a single loop through samples of the video region, the models applied to predict the chroma samples according to their classification into the respective classes.

### CROSS REFERENCE TO RELATED APPLICATIONS

This application claims the benefit of European Application No. 23305278.6, filed on Mar. 2, 2023, which is incorporated herein by reference in its entirety.

### BACKGROUND

Predictive video coding employs prediction to leverage spatial and temporal redundancy in the video's content. Generally, to encode a video block, intra-prediction or inter-prediction is applied to the video block to exploit spatial or temporal correlations, then the difference between the original video block and the predicted video block is transformed, quantized, and entropy encoded. To reconstruct the video block, inverse processes corresponding to the entropy encoding, quantization, transformation, and prediction are applied. Cross-component based intra-prediction techniques may be used by the encoder, where a chroma sample is predicted based on reconstructed luma samples according to a prediction model that is derived from reference samples spatially associated with the chroma sample. Using a large number of reference samples and of model parameters may increase the accuracy of the chroma sample prediction. However, the increased prediction accuracy may be obtained at the price of increased computational complexity associated with both deriving and applying the prediction model.

### SUMMARY

Aspects disclosed in the present disclosure describe methods for encoding and decoding video data. The methods include obtaining video data, including data representing a video data region, and then computing models used for cross-component based prediction of chroma samples from the video data region. The computing of models includes accumulating concurrently data of a first model and of a second model using a first loop through reference samples selected from the video data. In an aspect, the accumulated data of the first model and of the second model are generated based on the reference samples according to their respective classification into a first class and a second class. In another aspect, parameters of the first model and the second model can be rescaled into a lower bit size representation. The first model and the second model are then applied using a second loop through samples of the video region, the models applied to predict the chroma samples according to their classification into the first class or the second class.

Aspects disclosed in the present disclosure describe apparatuses for encoding and decoding video data. The apparatuses comprise at least one processor and memory storing instructions. The instructions, when executed by the at least one processor, cause the apparatuses to obtain video data, including data representing a video data region, and then compute models used for cross-component based prediction of chroma samples from the video data region. The computing of the models includes accumulating concurrently data of a first model and of a second model using a first loop through reference samples selected from the video data. In an aspect, the accumulated data of the first model and of the second model are generated based on the reference samples according to their respective classification into a first class and a second class. In another aspect, parameters of the first model and the second model can be rescaled into a lower bit size representation. The instructions further cause the system to apply the first model and the second model using a second loop through samples of the video region, the models applied to predict the chroma samples according to their classification into the first class or the second class.

Further aspects disclosed in the present disclosure describe a non-transitory computer-readable medium comprising instructions executable by at least one processor to perform methods for encoding and decoding video data. The methods include obtaining video data, including data representing a video data region, and then computing models used for cross-component based prediction of chroma samples from the video data region. The computing of the models includes accumulating concurrently data of a first model and of a second model using a first loop through reference samples selected from the video data. In an aspect, the accumulated data of the first model and of the second model are generated based on the reference samples according to their respective classification into a first class and a second class. In another aspect, parameters of the first model and the second model can be rescaled into a lower bit size representation. The first model and the second model are then applied using a second loop through samples of the video region, the models applied to predict the chroma samples according to their classification into the first class or the second class.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 is a block diagram of an example system, according to which aspects of the present embodiments can be implemented.

FIG. 2 is a functional block diagram of an example video encoder, according to which aspects of the present embodiments can be implemented.

FIG. 3 is a functional block diagram of an example video decoder, according to which aspects of the present embodiments can be implemented.

FIG. 4 is a diagram illustrating a reference area for a CC-based prediction, according to which aspects of the present embodiments can be implemented.

FIG. 5 is a diagram illustrating a multi-model CC-based prediction, according to which aspects of the present embodiments can be implemented.

FIG. 6 is a flowchart of an example method for a CC-based prediction, according to which aspects of the present embodiments can be implemented.

FIG. 7 is a flowchart illustrating derivation of models for a CC-based prediction, according to which aspects of the present embodiments can be implemented.

FIG. 8 is a flowchart illustrating the application of a multi-model CC-based prediction, according to which aspects of the present embodiments can be implemented.

FIG. 9 is a flowchart illustrating joint derivation of models for a CC-based prediction, according to which aspects of the present embodiments can be implemented.

FIG. 10 is a flowchart illustrating the joint application of a multi-model CC-based prediction, according to which aspects of the present embodiments can be implemented.

FIG. 11 is a flowchart of an example method, according to which aspects of the present embodiments can be implemented.

### DETAILED DESCRIPTION

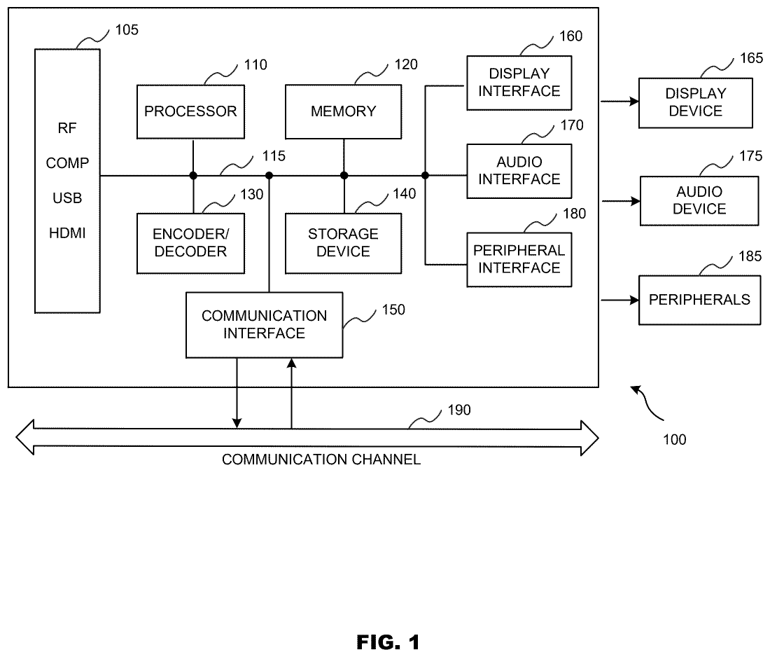

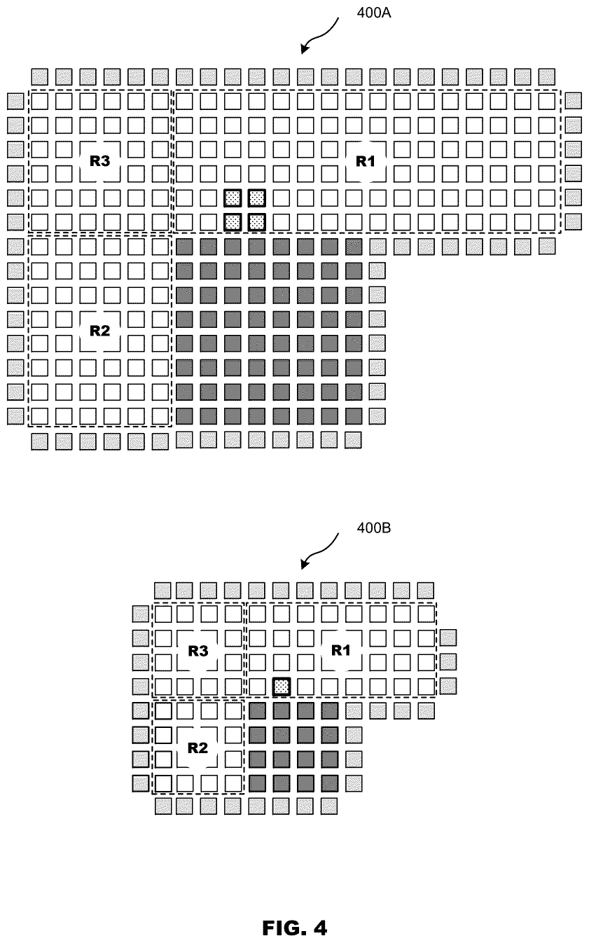

Apparatuses and methods are disclosed herein for video encoding and video decoding. Aspects of the present disclosure describe techniques for reducing the computational complexity of deriving and applying models for cross-component based intra-prediction. Traditional systems and methods for predictive video coding are described next in reference to FIGS. 1-3, followed by description of aspects of the present disclosure, described in reference to FIGS. 4-11.

FIG. 1 illustrates a block diagram of an example system 100. System 100 can be embodied as a device and can be configured to perform one or more of the aspects described in this application. Examples of such devices, include, but are not limited to, various electronic devices such as personal computers, laptop computers, smartphones, tablet computers, digital multimedia set-top boxes, digital television receivers, personal video recording systems, connected home appliances, and servers. Elements of system 100, singly or in combination, can be embodied in an integrated circuit, multiple integrated circuits, and/or discrete components. For example, in at least one embodiment, the processing 110 and encoder/decoder 130 elements of system 100 are distributed across multiple integrated circuits and/or discrete components. In various embodiments, the system 100 is communicatively coupled to other systems, or to other electronic devices, via, for example, a communications bus or through dedicated input and/or output ports.

The system 100 includes at least one processor 110 that can be configured to execute instructions loaded therein for implementing, for example, the various aspects described in this application. Processor 110 can include embedded memory, input and output interfaces, and various other circuitries as known in the art. The system 100 includes at least one memory 120, such as a volatile memory device and/or a non-volatile memory device. System 100 includes a storage device 140, which can include non-volatile memory and/or volatile memory, such as EEPROM, ROM, PROM, RAM, DRAM, SRAM, flash, magnetic disk drives, and/or optical disk drives. The storage device 140 can be an internal storage device, an attached storage device, and/or a network accessible storage device, for example.

System 100 includes an encoder/decoder module 130 configured to process data to provide encoded video data or decoded video data. The encoder/decoder module 130 can include its own processor and memory. The encoder/decoder module 130 can be implemented as a separate element of system 100 or can be incorporated within processor 110 as a combination of hardware and/or software as known to those skilled in the art. Additionally, the encoder/decoder module 130 represents module(s) that can be implemented in a separate device to perform encoding and/or decoding functions.

Program code that is to be loaded into processor 110 or into encoder/decoder 130 to perform the various aspects described in this application can be stored in a storage device 140 and subsequently loaded into memory 120 for execution by processor 110. In accordance with various embodiments, one or more of processor 110, memory 120, storage device 140, and encoder/decoder module 130 can store one or more of various items during the performance of the processes described in this application. Such stored items can include, but are not limited to, the input video, the decoded video or portions of the decoded video, the bitstream, matrices, variables, operational logic, and intermediate or final results from the processing of equations, formulas, operations.

In several embodiments, memory inside of the processor 110 and/or the encoder/decoder module 130 is used to store instructions and to provide working memory for processing functions that are needed during encoding or decoding. In other embodiments, however, memory external to the processing device (where, for example, the processing device can be either the processor 110 or the encoder/decoder module 130) can be used for one or more of these functions. The external memory can be the memory 120 and/or the storage device 140 that may comprise, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations.

The input to the elements of system 100 can be provided through various input devices as indicated in block 105. Such input devices include, but are not limited to, (i) an RF portion that receives an RF signal transmitted, for example, over the air by a broadcaster, (ii) a Composite input terminal (COMP), (iii) a USB input terminal, and/or (iv) an HDMI input terminal.

In various embodiments, the input devices of block 105 have associated respective input processing elements as known in the art. For example, the RF portion can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select, for example, a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements that perform these functions, for example, frequency selectors, signal selectors, band-limiters, channel selectors, filters, downconverters, demodulators, error correctors, and demultiplexers. The RF portion can include a tuner that performs some of these functions, including, for example, down-converting the received signal to a lower frequency (for example, an intermediate frequency or a near-baseband frequency) or to a baseband. In one set-top box embodiment, the RF portion and its associated input processing element receive an RF signal transmitted over a wired (for example, cable) medium, and perform frequency selection by filtering, down-converting, and filtering again to a desired frequency band. Various embodiments rearrange the order of the above-described (and other) elements, remove some of these elements, and/or add other elements performing similar or different functions. Added elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 100 to other electronic devices across USB and/or HDMI connections. It is to be understood that various aspects of input processing, for example, Reed-Solomon error correction, can be implemented, for example, within a separate input processing integrated circuit or within processor 110 as necessary. Similarly, aspects of USB or HDMI interface processing can be implemented within separate interface integrated circuits or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 can be provided within an integrated housing. Within the integrated housing, the various elements can be interconnected and transmit data therebetween using a suitable connection arrangement 115, for example, an internal bus as known in the art, including the I2C bus, wiring, and printed circuit boards.

The system 100 includes communication interface 150 that enables communication with other devices via communication channel 190. The communication interface 150 can include, but is not limited to, a transceiver configured to transmit and to receive data over communication channel 190. The communication interface 150 can include, but is not limited to, a modem or network card. The communication channel 190 can be implemented, for example, within a wired and/or a wireless medium.

Data can be streamed to the system 100, in various embodiments, using a Wi-Fi network such as IEEE 802.11. The Wi-Fi signal of these embodiments is received over the communication channel 190 and the communication interface 150 which can be adapted for Wi-Fi communications. The communication channel 190 of these embodiments is typically connected to an access point or router that provides access to outside networks including the Internet for allowing streaming applications and other over-the-top communications. In other embodiments, data can be streamed to the system 100 using a set-top box that delivers the data over the HDMI connection of the input block 105 or data can be streamed to the system 100 using the RF connection of the input block 105.

The system 100 can provide an output signal to various output devices, including a display device 165, an audio device (e.g., speaker(s)) 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display device 165, the audio device 175, or the other peripheral devices 185 using signaling such as AV.link, CEC, or other communication protocols that enable device-to-device control with or without user intervention. The output devices can be communicatively coupled to system 100 via dedicated connections through respective interfaces 160, 170, and 180. Alternatively, the output devices can be connected to system 100 using the communication channel 190 via the communication interface 150. The display device 165 and the audio device 175 can be integrated in a single unit with the other components of system 100 in an electronic device, for example, a television. In various embodiments, the display interface 160 includes a display driver, for example, a timing controller (T Con) chip.

Alternatively, the display device 165 and the audio device 175 can be separate from one or more of the other components, for example, if the RF portion of input 105 is part of a separate set-top box. In various embodiments in which the display device 165 and the audio device 175 are external components, the output signal can be provided via dedicated output connections, including, for example, HDMI ports, USB ports, or COMP outputs.

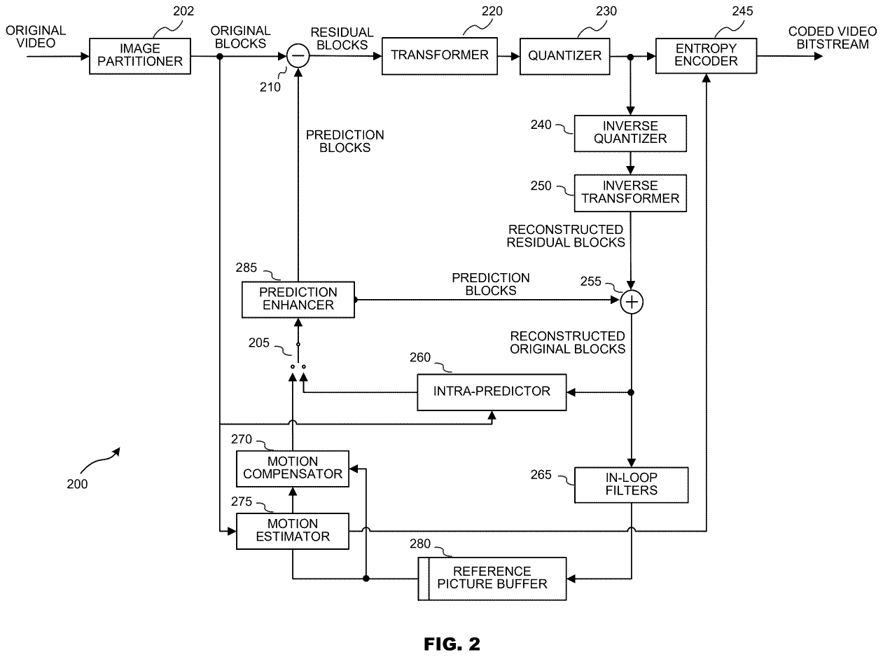

FIG. 2 illustrates a functional block diagram of an example video encoder 200. The video encoder 200 can be employed by the system 100 described in reference to FIG. 1. For example, the video encoder 200 can be an encoder that operates according to coding standards such as Advanced Video Coding (AVC, H.264/MPEG-4|ISO/IEC 14496-10), High Efficiency Video Coding (HEVC, ITU-T H.265|ISO/IEC 23008-2), or Versatile Video Coding (VVC, Standard ITU-T H.266, ISO/IEC 23090-3, 2020).

Prior to undergoing encoding, the video data can be pre-processed by a precoding processor (not shown). Such pre-processing can include applying a color model transform to the color components of the input video frames (e.g., conversion from RGB 4:4:4 to YCbCr 4:2:0) or mapping the color components of the input video frames to obtain a signal distribution that is more resilient to compression (for instance, applying a histogram equalizer and/or a denoising filter to one or more of the video frames' color components). The pre-processing can also include associating metadata with the video data that can be attached to the coded video bitstream.

In the encoder 200, a video frame is encoded by the encoder elements as generally described below. A picture (frame) of the original video to be encoded is partitioned into coding units (namely, original blocks) by an image partitioner 202. Typically, a coding unit (CU) contains a luminance block and respective chroma blocks, and so, generally, operations described herein as applied to a CU are applied to the luminance block and to the respective chroma blocks. Following partition 202, each CU can be encoded using an intra-prediction mode or an inter-prediction mode. In an intra-prediction mode, a prediction of the CU is performed by an intra-predictor 260. In the intra-prediction mode, the content of a CU in a frame is predicted based on content from one or more other CUs of the same frame, using the other CUs' reconstructed version (available from the adder 255 output). In an inter-prediction mode, motion estimation and motion compensation are performed by a motion estimator 275 and a motion compensator 270, respectively. In the inter-prediction mode, the content of a CU in a frame is predicted based on content from one or more other CUs of neighboring frames, using the other CUs' reconstructed versions (available from the reference picture buffer 280). The encoder decides 205 which prediction result (one obtained through operations in the intra-prediction mode 260 or one obtained through operations in the inter-prediction mode 270, 275) to use for encoding a CU, and indicates the selected prediction mode by a prediction mode flag, for example. The selected prediction result may then be enhanced (e.g., filtered) by a prediction enhancer 285, outputting a respective prediction block. Once a prediction block is generated for each CU, a respective residual block is calculated, for example, by subtracting 210 the predicted CU (i.e., prediction block) from the CU (i.e., original block).

A CU's respective residual block or a partition thereof (i.e., a transform block) is then transformed into a coefficient block by a transformer 220—that is, residual samples of the transform block are transformed into transform coefficients of the coefficient block. The resulting coefficient block is quantized by a quantizer 230. An entropy encoder 245 is next employed to entropy-encode the quantized coefficient block and respective coding parameters (e.g., syntax elements including motion vectors and other control data). Hence, the entropy-encoded quantized coefficient blocks and respective encoding parameters associated with each video frame of the original video are packed into the bitstream of the coded video data.

Along with the coding of original blocks (CUs), as described above, the encoder 200 reconstructs the coded original blocks to provide references for future predictions. Accordingly, quantized coefficient blocks (provided by the quantizer 230) are de-quantized, by an inverse quantizer 240, and then inverse transformed, by an inverse transformer 250, to reconstruct (decode) the residual blocks of respective original blocks. Adding 255 the reconstructed residual blocks to respective prediction blocks results in respective reconstructed original blocks. In-loop filters 265 can then be applied to the reconstructed picture (formed by the reconstructed original blocks), performing, for example, deblocking filtering and/or sample adaptive offset (SAO) filtering to reduce encoding artifacts. The filtered reconstructed picture can then be stored in the reference picture buffer 280, available for future predictions in an inter-prediction mode. Thus, the encoder 200 also performs decoding operations 240, 250 through which the encoded pictures (frames) are reconstructed. The reconstructed pictures can then be stored in the reference picture buffer 280 and be used to facilitate motion estimation 275 and compensation 270, as explained above.

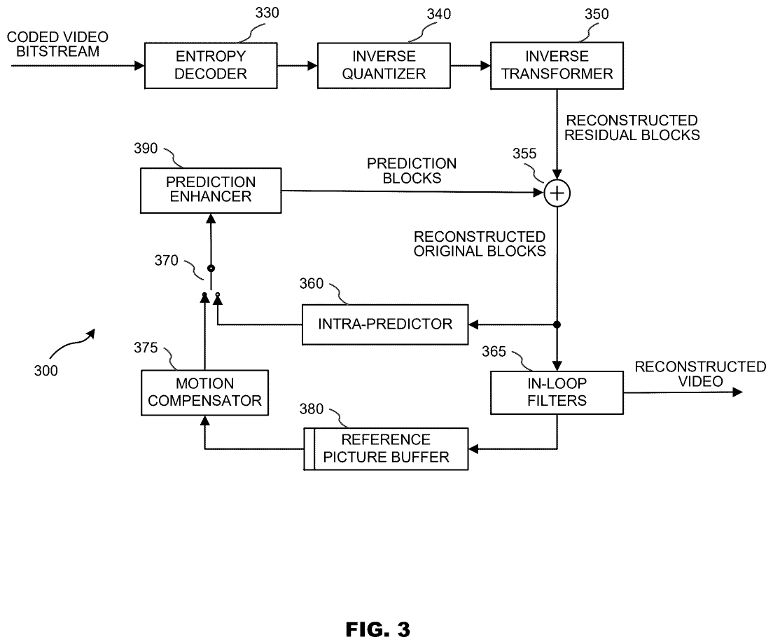

FIG. 3 illustrates a functional block diagram of an example video decoder 300. The video decoder 300 can be employed by the system 100 described in reference to FIG. 1. Generally, operational aspects of the video decoder 300 are reciprocal to operational aspects of the video encoder 200. In the decoder 300, the bitstream of coded video data, generated by the video encoder 200, is first entropy-decoded by an entropy decoder 330, decoding from the bitstream the quantized coefficient blocks and various coding parameters. The quantized coefficient blocks are de-quantized, by an inverse quantizer 340, and then are inverse transformed, by an inverse transformer 350, to decode (reconstruct) respective residual blocks. Adding 355 the reconstructed residual blocks to respective prediction blocks results in respective reconstructed original blocks. Depending on the selected prediction mode, a predicted original block can be obtained 370 from an intra-predictor 360 or from a motion compensator 375 and may then be enhanced (e.g., filtered) by a prediction enhancer 390, generating a prediction block. In-loop filters 365 can be applied to the reconstructed picture (formed by the reconstructed original blocks), outputting a reconstructed (decoded) video frame. The filtered reconstructed picture is also stored in a reference picture buffer 380 to facilitate motion compensation 375.

A post-decoding processor (not shown) can further process the reconstructed video. For example, post-decoding processing can include an inverse color model transform (e.g., conversion from YCbCr 4:2:0 to RGB 4:4:4) or an inverse mapping to reverse the mapping process performed by the pre-encoding processor. The post-decoding processor can use metadata that were derived by the pre-encoding processor and/or were signaled in the video bitstream.

Aspects disclosed herein are described in reference to a CU, however, the described aspects are similarly applicable to any region of the video frame (i.e., video data region) that intra-prediction can be applied to by an encoder 260 or by a decoder 360. Generally, aspects described herein may be applied to a video data region formed by a video partition of any shape or size.

A CU includes a luma component, Y, and chroma components, Cr and Ch (either one of which is referred to herein also by C). Typically, a chroma component C is subsampled, and, so, has a reduced resolution relative to the corresponding luma component Y. Generally, the image content of a chroma component C is correlated with the image content of the corresponding luma component Y and its close spatial neighborhood. To take advantage of such cross-component correlation, approaches exist that predict a chroma sample, from a chroma component C, based on corresponding luma sample(s) derived from a reconstructed corresponding luma component Y. Several of these approaches, generally referred to herein as cross-component (CC) based predictions, apply models that are described below-including cross-component linear model (CCLM), convolutional cross-component model (CCCM), and gradient and location based convolutional cross-component model (GL-CCCM).

A CCLM is a model for a CC-based prediction, where chroma samples from the C component of a CU (that is coded in an intra-prediction mode) are linearly predicted based on respective luma samples from the reconstructed and subsampled Y component of the CU, denoted Yᵣₛ. Thus, the linear prediction of a chroma sample at a pixel location (i, j), that is, a chroma sample C(i, j), can be expressed as follows:

$${C}_{p}^{CCLM} ( i , j ) = α \cdot {Y}_{r s} ( i , j ) + β , \qquad ( 1 )$$

where,

$${C}_{p}^{CCLM} ( i , j )$$

indicates a predicted chroma sample at a pixel location (i, j), and Yᵣₛ(i, j) indicates a luma sample at the pixel location (i, j). The parameters α and β of the linear model shown in equation (1) can be estimated, for example, based on reference samples and by using a least-squares optimization algorithm that finds the parameters α and β that minimize the model's sum of squared errors. The model's error can be formulated as follows:

$$E ( n ) = {c}_{ref} ( n ) - ( α \cdot {y}_{ref} ( n ) + β ) , n ∈ 1 : N , \qquad ( 2 )$$

where, a pair of y_{ref}(n) and c_{ref}(n) indicates, respectively, a reference luma sample and a corresponding reference chroma sample, indexed by n∈1:N. And, where a pair of y_{ref}(n) and c_{ref}(n) reference samples are derived, respectively, from reconstructed luma and chroma samples that are in the vicinity of the CU for which the prediction is performed (according to equation (1)). Hence, a least-squares optimization algorithm finds the optimal values for α and β that minimize the sum of squared errors.

$$E = {\sum }_{n = 1}^{N} {E ( n )}^{2} .$$

The N pairs of reference samples—that is, pairs (y_{ref}(n), c_{ref}(n)) for n∈1:N, can be selected according to different schemes, as further described below.

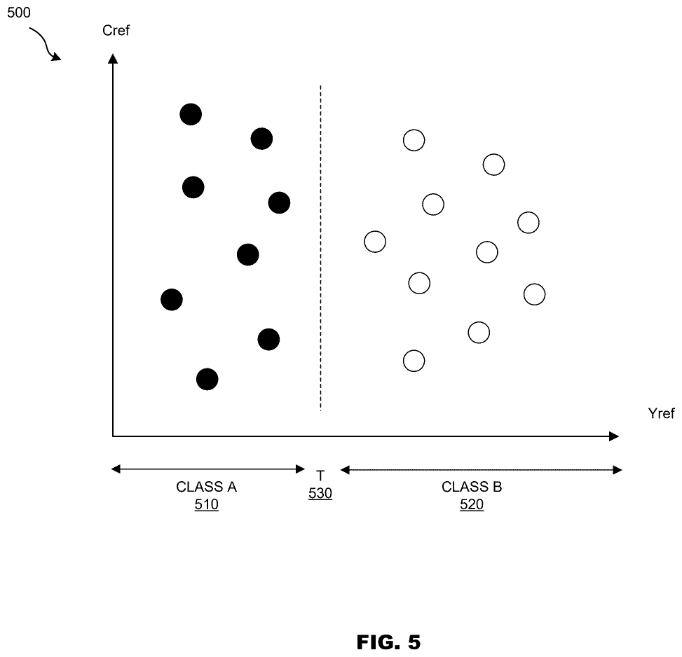

Several variants to CCLM exist. The variation can be with respect to 1) the location and/or the number N of the reference pairs used to estimate the model's parameters α and β; 2) the method for estimating the model's parameters; or 3) the type of filter that may be used when down-sampling the luma component Y into its down-sampled version Yᵣₛ. For example, when an Enhanced Compression Model (ECM) is used (see, M. Coban, et al., “Algorithm description of Enhanced Compression Model 4 (ECM 4),” document JVET-Y2025, 23rd Meeting, by teleconference, 7-16 Jul. 2021), the CCLM included in the VVC is extended by adding three multi-model linear model (MMLM) modes (see, K. Zhang, et al., “Enhanced Cross-component Linear Model Intra-prediction,” document JVET-D0110). A multi-model CC-based prediction is described below with respect to FIG. 5.

A CCCM is another model for a CC-based prediction (see, P. Astola, et al., “AHG12: Convolutional cross-component model (CCCM) for intra prediction,” document JVET-Z0064, 26th Meeting, by teleconference, 20-29 Apr. 2022). Similar to CCLM, a CCCM can be used to predict chroma samples based on corresponding subsampled reconstructed luma samples. Also, similar to CCLM, there is an option of using a single model or a multi-model variant of CCCM, as described with respect to FIG. 5. Preferably, a multi-model CCCM should be selected when a large number of reference pairs are available (e.g., N≥128).

The parameters of a CCCM include a 3×3 kernel K, a nonlinear term p, and a bias term b. The kernel K is a plus sign shaped kernel, having kernel coefficients k_{C}, k_{N}, k_{S}, k_{W}, and k_{E} that are situated, respectively, at the center, north, south, west, and east of the pixel location that the kernel is convolved with. For example, applying the kernel K to a luma sample Yᵣₛ(i, j), the convolution result, Yᵣₛ(i, j)*K, is:

$${Y}_{r s} ( i , j ) * K = {Y}_{r s} ( i , j ) \cdot {k}_{C} + {Y}_{r s} ( i , j - 1 ) \cdot {k}_{N} + {Y}_{r s} ( i , j + 1 ) \cdot {k}_{S} + {Y}_{r s} ( i - 1 , j ) \cdot {k}_{W} + {Y}_{r s} ( i + 1 , j ) \cdot {k}_{E} . \qquad ( 3 )$$

The nonlinear term p can be determined as the power of two of Yᵣₛ(i, j) that is scaled to the used bit depth. For example, for a bit depth of 10 bits, the nonlinear term p can be:

$$p ≡ P ( {{Y}_{r s} ( i , j )}^{2} ) = ( {{Y}_{r s} ( i , j )}^{2} + 512 ) ≫ 10. \qquad ( 4 )$$

The bias term b can be determined as the middle chroma value (e.g., 512 for 10-bit content).

Hence, prediction of a chroma sample based on a CCCM model can be expressed as follows:

$${C}_{p}^{CCCM} ( i , j ) = {Y}_{r s} ( i , j ) * K + α \cdot P ( {{Y}_{r s} ( i , j )}^{2} ) + β \cdot b , \qquad ( 5 )$$

where

$${C}_{p}^{CCCM} ( i , j )$$

indicates a predicted chroma sample at a pixel location (i, j) and where Yᵣₛ(i, j) indicates a corresponding luma sample at the same pixel location (i, j). Note that

$${C}_{p}^{CCCM} ( i , j )$$

can be further clipped to the range of the chroma sample. Thus, the CCCM model parameters are (k_{C}, k_{N}, k_{S}, k_{W}, k_{E}, α, β). Similar to the CCLM, these parameters can be estimated by minimizing the sum of squared errors, as follows:

$$E ( n ) = {c}_{ref} ( n ) - ( {y}_{ref} ( n ) * K + α \cdot P ( {{y}_{ref} ( n )}^{2} ) + β \cdot b ) , n ∈ 1 : N , \qquad ( 6 )$$

where, a pair of y_{ref}(n) and c_{ref}(n) indicates, respectively, a reference luma sample and a corresponding reference chroma sample, indexed by n∈1:N. And, where a pair of y_{ref}(n) and c_{ref}(n) reference samples are derived, respectively, from reconstructed luma and chroma samples that are in the vicinity of the CU for which the prediction is performed (according to (5)). Hence, a least-squares optimization algorithm can be used to find the optimal values for the model's parameters (k_{C}, k_{N}, k_{S}, k_{W}, k_{E}, α, β) that minimize the sum of squared errors

$$E = {\sum }_{n = 1}^{N} {E ( n )}^{2} .$$

The N reference pairs y_{ref}(n) and c_{ref}(n) can be selected from a reference area, as further explained with reference to FIG. 4.

The prediction of a chroma sample Cₚ(i, j) according to CCCM (as formulated in equation (5)) can be expressed as follows:

$${C}_{p}^{CCCM} ( i , j ) = {s}^{T} \cdot ϕ , \qquad ( 7 )$$

where, the (⋅) and the T operators represent, respectively, a dot product and a matrix transpose operation; φ=(φ₀, φ₁, φ₂, φ₃, φ₄, φ₅, φ₆)=(k_{C}, k_{N}, k_{S}, k_{W}, k_{E}, α, β) is a column vector containing the CCCM model's parameters; and s=[Yᵣₛ(i, j), Yᵣₛ(i, j−1), Yᵣₛ(i, j+1), Yᵣₛ(i−1, j), Yᵣₛ(i+1, j), p, b] is a column vector, namely, an observation vector. Note that both vectors φ and s have the same dimension, denoted by M.

As explained above, the parameter vector φ can be estimated by minimizing the model's sum of squared errors, as follows:

$$E ( n ) = {c}_{ref} ( n ) - {{s}_{ref} ( n )}^{T} \cdot ϕ , n ∈ 1 : N , \qquad ( 8 )$$

where n indexes a location (i, j) within the used reference area, and so s_{ref}(n)=[yᵣₛ(i, j), yᵣₛ(i, j−1), yᵣₛ(i, j+1), yᵣₛ(i−1, j), yᵣₛ(i+1, j), p, b] and c_{ref}(n)=c_{ref}(i, j). Thus, the optimal value for φ that minimizes the sum of squared errors

$$E = {\sum }_{n = 1}^{N} {E ( n )}^{2}$$

can be derived by:

$$ϕ = {( S \cdot {S}^{T} )}^{- 1} S \cdot {C}_{ref} = {A}^{- 1} \cdot B \qquad ( 9 )$$

where, S=[s(1), s(2), . . . , s(N)] is a matrix of M by N dimension, and C_{ref}=[c_{ref}(1), c_{ref}(2), . . . , c_{ref}(N)] is a column vector of N dimension. Note that the matrix A≡(S·S^{T}) is an auto-correlation matrix of M by M dimension and the vector B≡S·C_{ref} is a cross-correlation vector of dimension M. Hence, the elements of the autocorrelation matrix can be computed by:

$${A}_{k , l} = {\sum }_{n = 1}^{N} {s}_{i} ( n ) \cdot {s}_{j} ( n ) , \qquad ( 10 )$$

and the elements of the cross-correlation vector can be computed by:

$${B}_{k} = {\sum }_{n = 1}^{N} {s}_{k} ( n ) \cdot {C}_{ref} ( n ) , \qquad ( 11 )$$

where, the observation vector s(n) is associated with a reference sample (i, j) that is indexed by n. The elements of an observation vector s(n) are referred to herein by: sₖ₌₀(n)=yᵣₛ(i, j), sₖ₌₁(n)=yᵣₛ(i, j−1), sₖ₌₂(n)=yᵣₛ(i, j+1), and so on.

As shown in equation (9), to derive the model's parameter vector φ the autocorrelation matrix A has to be inverted. For example, the autocorrelation matrix can be decomposed according to an LDL^{T} decomposition and the parameter vector φ can then be computed using back-substitution. Generally, this process follows adaptive loop filtering (ALF) when ECM is used (see, M. Coban, et al., “Algorithm description of Enhanced Compression Model 7 (ECM 7),” document JVET-AB2025, 28th Meeting, by teleconference, October 2022). LDL^{T} decomposition is used instead of Cholesky decomposition (thus, also known as the alternative Cholesky decomposition) to avoid using square root operations. In another variant, a Gaussian elimination technique can be used to invert the autocorrelation matrix (see, J. Lainema, et al., “AHG12: Simplified linear model solver,” document JVET-AC0053, 29th Meeting, by teleconference, 11-20 Jan. 2023). When ECM is used, the autocorrelation matrix inversion computation uses integer 64-bits arithmetic.

Yet another model for a CC-based prediction is the GL-CCCM. In this model gradient information and location information are used for prediction (see, RG. Youlavari, et al., “EE2-1.12: Gradient and location based convolutional cross-component model (GL-CCCM) for intra prediction,” document JVET-AC0054, 29th Meeting, by teleconference, 11-20 Jan. 2023). Hence, the GL-CCCM can be expressed as follows:

$${C}_{p}^{G L - CCCM} ( i , j ) = {s}^{T} \cdot ϕ , \qquad ( 12 )$$

where, s=[Yᵣₛ(i, j), Gₓ(i, j), G_{y}(i, j), i, j, p, b] is a column vector formed based on luma samples associated with location (i, j) and φ=(φ₀, φ₁, φ₂, φ₃, φ₄, φ₅, φ₆) is a column vector containing the GL-CCCM model's parameters. The dimension of both vectors s and φ is denoted by M. The (⋅) and T operators represent, respectively, a dot product and a matrix transpose operation. The gradients, Gₓ(i, j) and G_{y}(i, j), can be derived as follows:

$${G}_{x} ( i , j ) = ( 2 \cdot {Y}_{r s} ( i - 1 , j ) + {Y}_{r s} ( i - 1 , j - 1 ) + {Y}_{r s} ( i - 1 , j + 1 ) ) - ( 2 \cdot {Y}_{r s} ( i + 1 , j ) + {Y}_{r s} ( i + 1 , j - 1 ) + {Y}_{r s} ( i + 1 , j + 1 ) ) \qquad ( 13 )$$

$$and$$

$${G}_{y} ( i , j ) = ( 2 \cdot {Y}_{r s} ( i , j - 1 ) + {Y}_{r s} ( i - 1 , j - 1 ) + {Y}_{r s} ( i + 1 , j - 1 ) ) - ( 2 \cdot {Y}_{r s} ( i , j + 1 ) + {Y}_{r s} ( i - 1 , j + 1 ) + {Y}_{r s} ( i + 1 , j + 1 ) ) . \qquad ( 14 )$$

As with respect to CCCM, the parameter vector φ of GL-CCCM can be computed according to equations (9)-(11), obtained by minimizing the sum of squared errors.

As explained above, the reconstructed luma samples Yᵣ are down-sampled to match the lower resolution of the chroma samples C, forming the down-sampled luma samples Yᵣₛ. In an aspect, the down-sampling can be avoided by directly using reconstructed luma samples. For example (as in H. J. Jhu, et al., “EE2-1.13 and 1.14: CCCM using non-downsampled luma samples,” document JVET-AC0147, 29th Meeting, by teleconference, 11-20 Jan. 2023), the observation vector s, that is associated with a chroma sample that corresponds to location (i, j) in Yᵣₛ, can be:

$$s = [ {Y}_{r} ( i , j ) , {L}_{0} , {L}_{1} , {L}_{2} , {L}_{3} , {L}_{4} , {L}_{5} , {p}_{0} , {p}_{1} , {p}_{2} , {p}_{4} , b ] , \qquad ( 15 )$$

where L₀=Yᵣ(i−2, j−1), L₁=Yᵣ(i, j−1), L₂=Yᵣ(i+2, j−1), L₃=Yᵣ(i−2, j+1), L₄=Yᵣ(i, j+1), and L₅=Yᵣ (i+2, j+1). Elements p₀, p₁, p₂, p₄ represent a non-linear function of L₀, L₁, L₂, L₄, respectively. And the bias term b can be determined as the middle chroma value (e.g., 512 for 10-bit content). This model has 12 parameters φ=(φ₀, φ₁, φ₂, φ₃, φ₄, φ₅, φ₆, φ₇, φ₈, φ₉, φ₁₀, φ₁₁).

FIG. 4 is a diagram illustrating reference areas used for a CC-based prediction. In the example of FIG. 4, luma samples 400A and corresponding (subsampled) chroma samples 400B are shown. A luma block (e.g., from a CU or a partition thereof) and its corresponding chroma block are indicated by dark grey squares. A reference luma area, including reference luma samples y_{ref}(n), and a corresponding reference chroma area, including reference chroma samples c_{ref}(n), are indicated by white squares. Corresponding samples from the reference luma area and the reference chroma area can be used to compute the parameters of any of the above described models (e.g., CCLM, CCCM, or GL-CCCM). Thus, reference luma samples y_{ref}(n) and their corresponding reference chroma samples c_{ref}(n) can be selected from the respective reference areas. Since, the chroma content 400B is subsampled relative to the luma content 400A (for example when using a 4:2:0 format), a chroma sample corresponds to a luma sample that may be derived (or interpolated) from the luma content of four luma samples (e.g., the four luma samples indicated by the dotted squares in 400A are down-sampled into a luma sample that corresponds to the chroma sample indicated by the dotted square in 400B).

As shown in FIG. 4, three regions can be delineated within both the luma reference area and the chroma reference area: denoted R₁, R₂, and R₃. In an aspect, the reference samples may be selected from a region signaled explicitly in the bitstream (e.g., at the CU level). For example, the reference chroma and luma samples may be selected from regions R₁, R₂, R₃, or a combination thereof. An extended area (e.g., the samples indicated by light grey squares) may also be used to support filtering of the reference luma and chroma samples (white squares) located along the boundary of the luma and the chroma reference areas. For each luma and corresponding chroma blocks, a reference area is determined that includes reconstructed samples; however, if reconstructed samples are not available, padding may be applied. For example, the extended area can be used to support a convolution by the 3×3 kernel K (see, equation (3)), and if samples in this extended area are not available, they can be extrapolated from available reconstructed samples or they can be padded with zeros.

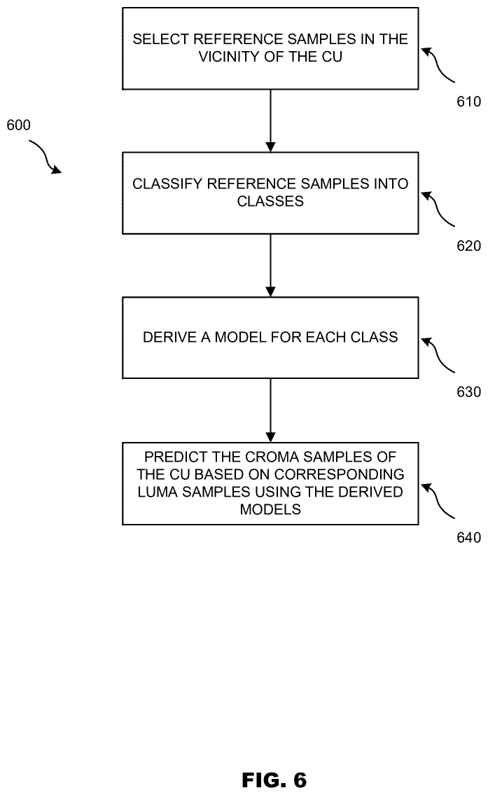

FIG. 5 is a diagram illustrating a multi-model CC-based prediction 500. A multi-model prediction may be used with any (or a combination) of the models described above (e.g., CCLM, CCCM, or GL-CCCM). When a multi-model predictor is applied, the N reference pairs (y_{ref}(n), c_{ref}(n)) that are used to derive the model's parameters are first classified into multiple classes. The classification may be based on a feature space (e.g., including a feature representing a luma sample's intensity level) that characterizes the reference luma samples y_{ref}(n) and/or the reference chroma samples c_{ref}(n). For example, in the case of two classes, class A 510 and class B 520, the reference pairs (y_{ref}(n), c_{ref}(n)) can be divided into two groups based on a threshold T 530. This threshold T can be determined, for example, based on the average of the pixel intensity levels of the N luma samples y_{ref}(n). As illustrated in FIG. 5, samples that are below (or equal to) the threshold are classified in a first class 510 (denoted by dark circles) and samples that are above the threshold are classified in a second class 520 (denoted by hollow circles). The model associated with each class can be derived (e.g., as described above with respect to equation (9)) based on the reference pairs within each class-resulting in a first model with a parameter vector φ_{A} that is derived based on reference pairs from class A 510 and a second model with a parameter vector φ_{B} that is derived based on reference pairs from class B 520. Accordingly, the first model can be used to predict a chroma sample with a corresponding luma sample that belongs to class A 510 and the second model can be used to predict a chroma sample with a corresponding luma sample that belongs to class B 520. A multi-model CC-based prediction, using any of the models described above for each of any number of classes, is generally described in reference to FIG. 6.

FIG. 6 is a flowchart of an example method for a CC-based prediction 600. The CC-based prediction method 600 predicts chroma samples of a CU (or a partition thereof) based on corresponding luma samples of the reconstructed and (potentially) subsampled luma samples of the CU. The method 600 begins, in step 610, by selecting reference samples—for example, N reference pairs y_{ref}(n) and c_{ref}(n) may be selected from the reference area, as described in reference to FIG. 4. In step 620, the reference samples are classified into multiple classes, if a multi-model prediction is applied, as described in reference to FIG. 5. If a single model prediction is applied, step 620 can be skipped, and all reference samples are considered as belonging to the same class. In step 630, a model is derived with respect to each class. Accordingly, for each model of a class, the model's parameter vector φ is derived based on the reference samples from the respective class. Then, in step 640, a chroma sample of the CU can be predicted based on the corresponding luma sample using the model (derived in step 630) that is associated with the class that the corresponding luma sample belongs to.

Generally, the reference samples in a reference area may be classified into Q classes. Such a classification may be based on features extracted from the luma samples and/or the chroma samples within the reference area. Respective models may be derived for the Q classes, resulting in respective parameter vectors {φ_{q}: q=1, . . . , Q}. Each parameter vector φ_{q} is used to predict a chroma sample based on a corresponding luma sample that belongs to its associated class q. An encoder 200, when performing a CC-based prediction, may be configured to select whether to apply a single model prediction (e.g., using a parameter vector do) or whether to apply a multi-model prediction (e.g., using parameter vectors {φ_{q}: q=1, . . . , Q}).

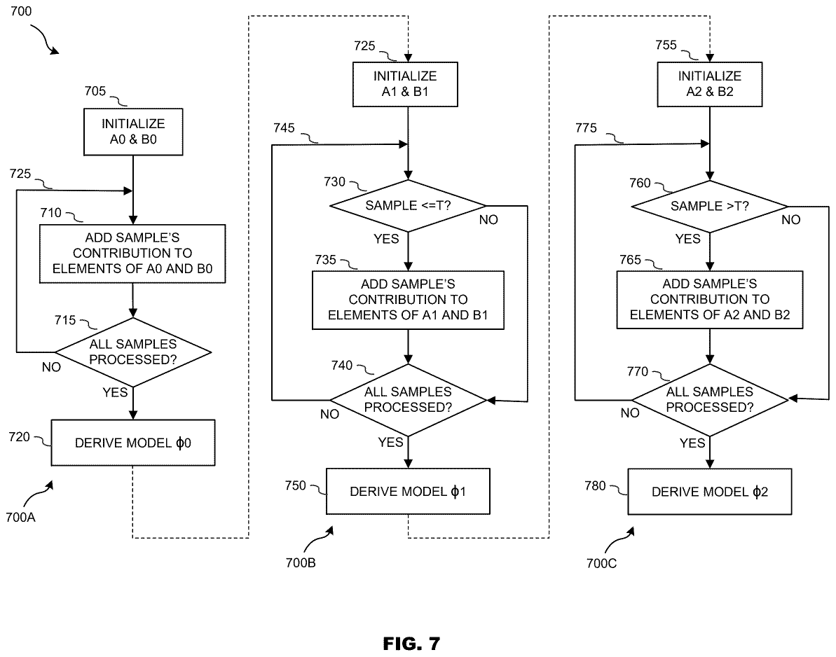

FIG. 7 is a flowchart illustrating derivation of models for a CC-based prediction 700. An encoder 200 may be configured to predict chroma samples of a CU based on the model that provides the better prediction, selecting between a single model φ₀ (derived as shown in flowchart part 700A) and multiple models φ₁ and φ₂ (derived as shown in flowchart parts 700B and 700C). As described with respect to equations (9)-(11), to derive these models the respective autocorrelation matrix A and cross-correlation vector B have to be computed. Accordingly, to derive model φ₀, autocorrelation matrix A₀ and cross-correlation vector B₀ are initialized 705. Then, N reference samples (e.g., samples selected from reference area R₁, R₂, R₃, or a combination thereof) are looped through 725 so that the contribution of each of these samples to the elements of A₀ and B₀ can be added 710 (e.g., according to equations (10) and (11)). When all the samples have been processed 715, model φ₀ is derived 720 (e.g., according to equation (9)). Next, to derive model φ₁, autocorrelation matrix A₁ and cross-correlation vector B₁ are initialized 725. Then, looping through the N reference samples 745, the contributions of the samples that belong to a first class (e.g., those with luma samples with intensity level equal or below a threshold T 730) are added to the elements of A₁ and B₁ 735 (e.g., according to equations (10) and (11)). When all the samples have been processed 740, model φ₁ is derived 750 (e.g., according to equation (9)). Similarly, to derive model φ₂, autocorrelation matrix A₂ and cross-correlation vector B₂ are initialized 755. Then, looping through the N reference samples 775, the contributions of the samples that belong to a second class (e.g., those with luma samples with intensity level above a threshold T 760) are added to the elements of A₂ and B₂ 765 (e.g., according to equations (10) and (11)). When all the samples have been processed 770, model φ₂ is derived 780 (e.g., according to equation (9)). Once models φ₀, φ₁, and φ₂ are derived 720, 750, 780, the encoder 200 may decide whether to predict the chroma samples of the CU based on the single model φ₀ or based on the multiple models φ₁ and φ2. For example, the encoder can apply both the single model and the multi-model to predict the chroma samples and can then select the one that yields the lower cost (e.g., rate-distortion cost).

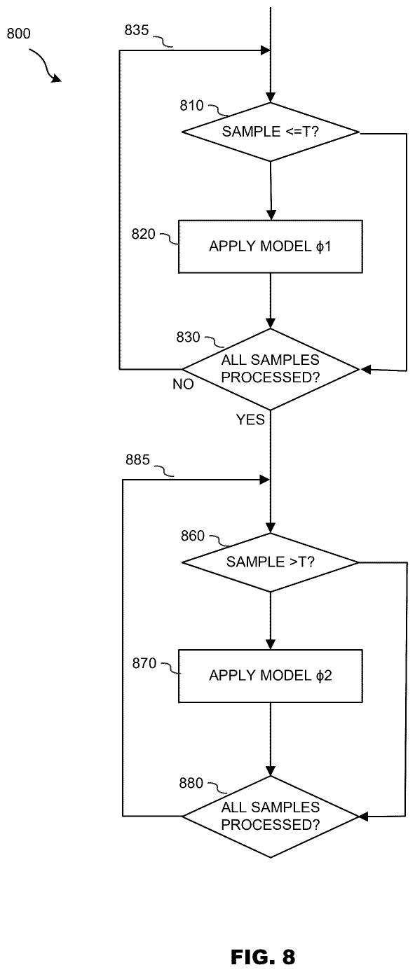

FIG. 8 is a flowchart illustrating the application of a multi-model CC-based prediction 800. Conventionally, multi-model prediction (e.g., based on CCCM) can be applied in two steps as shown in FIG. 8. First, chroma samples of the CU to be predicted are tested to see whether the samples belong to a first class (e.g., corresponding luma samples with intensity value equal or under a threshold T 810), looping 835 through the CU's samples until all samples are processed 830. Samples that are found to belong to the first class are predicted based on model φ₁ 820. Next, the samples of the CU to be predicted are tested to see whether the samples belong to a second class (e.g., corresponding luma samples with intensity value above a threshold T 860), looping 885 again through the CU's samples until all samples are processed 880. Samples that are found to belong to the second class are predicted based on model φ₂ 870.

The above CC-based prediction models have the following computational drawbacks. The computation of the autocorrelation matrices and the cross-correlation vectors associated with models φ₀, φ₁, and φ₂ involves two tests 730, 760 and three loops 725, 745, 775 through the reference samples, as explained in reference to FIG. 7. With respect to the application of the multi-model predictor, as shown in FIG. 8, prediction is carried out using two tests 810, 860 and two loops 835, 885 through the samples of the CU. Furthermore, the computation of the multi-model threshold T requires additional looping through the reference samples. Additionally, when computing the models' parameter vector, the auto-correlation matrix (which is a positive-definite symmetric matrix) has to be inverted, as shown in equation (9). Conventionally, the inversion is performed based on successive row substitutions with weighted linear combination of other rows. This computation is performed using integer arithmetic and the divisions are carried out by tabulated division (using a look up table). At the end of this process, large integer values may be obtained that require representation by 64-bit integers. Consequently, when the model is applied to estimate a chroma sample (see equation (7) or (12)), this estimation may require costly resources in terms of computational operations applied to 64 bit data as well as memory access and storage of the 64 bit data.

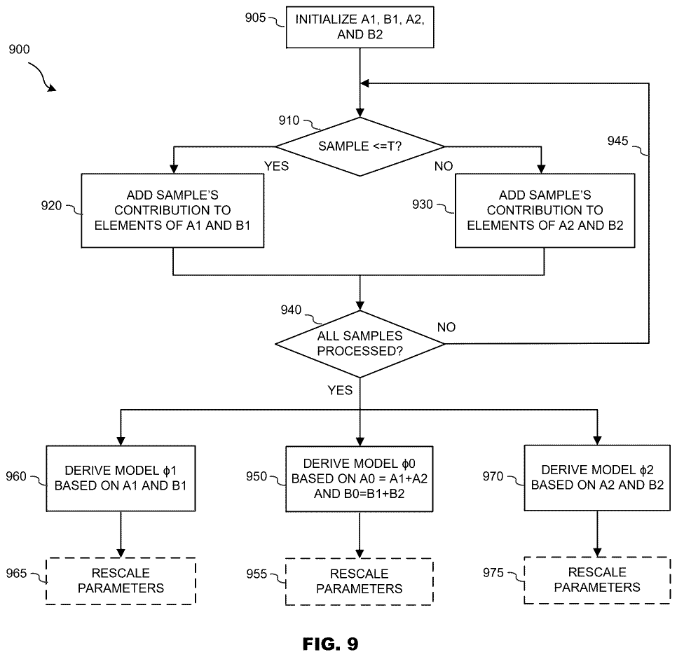

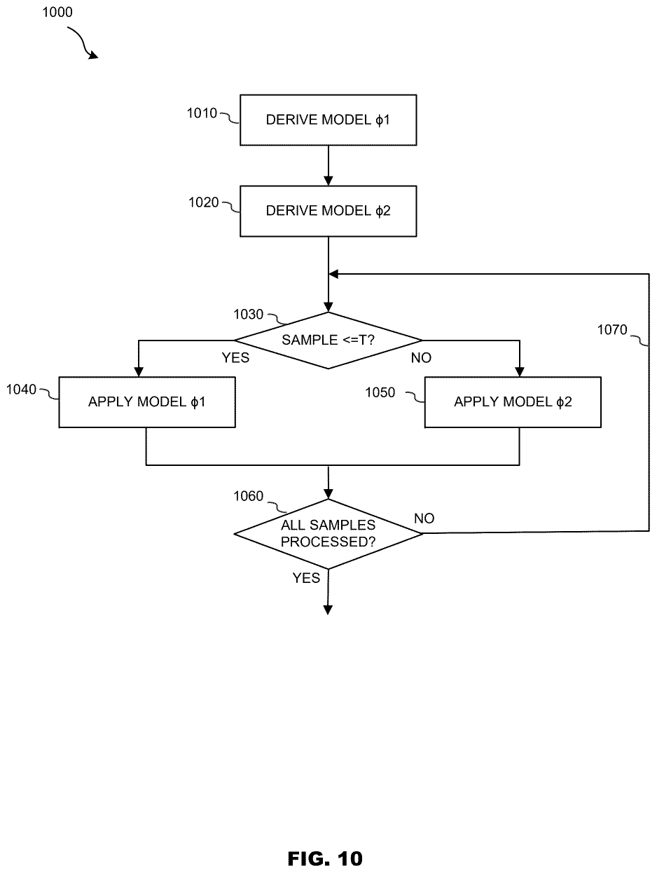

Aspects of the present disclosure address the drawbacks described above. According to aspects, computation of the auto-correlation matrices and the cross-correlation vectors associated with models φ₀, φ₁, and φ₂ can be performed using a single test and a single loop through the reference samples, as further described with respect to FIG. 9. And the application of the multi-model can be performed using a single test and a single loop through the samples of the CU, as further described in reference to FIG. 10. Furthermore, as disclosed herein, the threshold T can be computed concurrently with the computation of the autocorrelation matrices and the cross-correlation vectors, saving the need for another loop through the reference samples. Additionally, to reduce computational complexity, the model parameters can be represented by a number of bits lower than 64-bits (e.g., 32-bits integers), as further described below.

FIG. 9 illustrates joint derivation of models for a CC-based prediction 900. In a joint model derivation 900, the autocorrelation matrices and the cross-correlation vectors of respective models φ₀, φ₁, and φ₂ are computed concurrently, and thus the computation can be accomplished with one looping through the reference samples, as explained next in reference to the example of FIG. 9. Hence, following the initialization 905 of auto-correlation matrices A₁ and A₂ and cross-correlation vectors B₁ and B₂, the joint model derivation 900 is carried out by first looping 945 through N reference samples that are used for the prediction of chroma samples associated with a CU (e.g., samples selected from reference area R₁, R₂, R₃, or a combination thereof). If a sample belongs to a first class (e.g., a class representing those luma samples with intensity value equal or below a threshold T 910), that sample's contribution to the elements of auto-correlation matrix A₁ and to the elements of cross-correlation vector B₁ is added to (or accumulated into) A₁ and B₁ 920, respectively. For example, in the case of a sample n that belongs to the first class, its contribution sᵢ(n)·sⱼ(n) will be added to element A_{i,j} of the auto-correlation matrix A₁ and its contribution sᵢ(n)·C(n) will be added to element Bᵢ of the cross-correlation vector B₁ (see equations (10) and (11)). Otherwise, if the sample belongs to a second class (e.g., a class representing those luma samples with intensity value above a threshold T 910), that sample's contribution to elements of its respective auto-correlation matrix A₂ and to elements of its respective cross-correlation vector B₂ will be added to (or accumulated into) A₂ and B₂ 930, respectively. For example, in the case of a sample n that belongs to the second class, its contribution sᵢ(n)·sⱼ(n) will be added to element A_{i,j} of auto-correlation matrix A₂ and its contribution sᵢ(n)·C(n) will be added to element Bᵢ of cross-correlation vector B₂ (see equations (10) and (11)). Once all the N reference samples have been processed 940, model φ₁ can be derived based on auto-correlation matrix A₁ and cross-correlation vector B₁ 960 (i.e., φ₁=(A₁)⁻¹B₁) and model φ₂ can be derived based on auto-correlation matrix A₂ and cross-correlation vector B₂ 970 (i.e., φ₂=(A₂)⁻¹B₂). To derive model φ₀, auto-correlation matrices A₁ and A₂ can be combined into A₀=A₁+A₂ and cross-correlation vectors B₁ and B₂ can be combined into B₀=B₁+B₂. Model φ₀ can then be derived based on auto-correlation matrix A₀ and cross-correlation vector B₀ 950 (i.e., φ₀=(A₀)⁻¹B₀).

Hence, in a joint model derivation 900 the elements of the autocorrelation matrices and the elements of the cross-correlation vectors (used to compute respective models φ₀ 950, φ₁ 960, and φ₂ 970) are accumulated using one test 910 and a single loop 945 through the reference samples associated with the CU. This is in contrast to the derivation of the models described above with respect to FIG. 7, wherein the accumulation of the elements of the autocorrelation matrices and the cross-correlations vectors (used to compute respective models φ₀ 720, φ₁ 750, and φ₂ 780) is done separately, using two tests 730, 760 and involving looping through the reference samples three times 725, 745, 775.

In an aspect, a reference region may be divided into multiple regions (e.g., regions R₁, R₂, and R₃ in FIG. 4), and autocorrelation matrices and cross-correlations vectors may be computed with respect to each region. As in the example of FIG. 9, a single loop can be used to go through the reference samples while accumulating the contributions of samples from different regions into respective autocorrelation matrices and cross-correlations vectors (e.g., forming A_{R}_{₁} and B_{R}_{₁}, A_{R}_{₂} and B_{R}_{₂}, and A_{R}_{₃} and B_{R}_{₃}) and then combining these autocorrelation matrices and the cross-correlations vectors (e.g., forming A=A_{R}_{₁}+A_{R}_{₂}+A_{R}_{₃} and B=B_{R}_{₁}+B_{R}_{₂}+B_{R}_{₃}). This approach allows for parallel computation of regional autocorrelation matrices and cross-correlations vectors. Furthermore, in an aspect, a single loop can be used to go through the reference samples while accumulating the contributions of samples from different regions and from different classes within each region into respective autocorrelation matrices and cross-correlations vectors. For example, in this aspect the following autocorrelation matrices and cross-correlations vectors can be formed: A_{R}_{₁}_{,q}_{₁} and B_{R}_{₁}_{,q}_{₁}; A_{R}_{₁}_{,q}_{₂} and B_{R}_{₁}_{,q}_{₂}; A_{R}_{₂}_{,q}_{₁} and B_{R}_{₂}_{,q}_{₁}; A_{R}_{₂}_{,q}_{₂} and B_{R}_{₂}_{,q}_{₂}; A_{R}_{₃}_{,q}_{₁} and B_{R}_{₃}_{,q}_{₁}; and A_{R}_{₃}_{,q}_{₂} and B_{R}_{₃}_{,q}_{₂}, where q₁ and q₂ denote two classes. These classes may be determined separately for each region or may be determined with respect to samples of the CU. For example, when the classes are determined based on the intensity value of the luma samples—that is, based on a threshold T that represents the average intensity—T can be computed based on luma samples from each region or based on luma samples from the CU. The computation of the latter is independent of the layout of the regions.

As mentioned above, conventionally, the multi-model CC-based prediction is applied in two steps, as described in reference to FIG. 8. Therein, two loops 835, 885 through the samples of the CU (of which chroma samples are predicted) are used and two different tests 810, 860 are applied. To decrease complexity, in an aspect, the two models of the multi-model CC-based prediction are first derived and next these models are applied using a single test and a single loop, as described with respect to FIG. 10.

FIG. 10 is a flowchart illustrating the joint application of a multi-model CC-based prediction 1000. In the example of FIG. 10, model φ₁ 1010 and model 1020 φ₂ are first derived, for example, as described with respect to FIG. 9. Then, the samples of the CU are looped through 1070 to carry out the application of these models. If a sample belongs to a first class (e.g., corresponding luma samples with intensity value equal or under a threshold T 1030), model φ₁ is applied 1040 to that sample (e.g., according to equation (7) or (12)). Otherwise, if the sample belongs to a second class (e.g., corresponding luma samples with intensity value above a threshold T 1030), model φ₂ is applied 1050 to that sample. The application 1040, 1050 of the models to the CU's samples continues until all the samples have been processed 1060. As mentioned above, in this aspect, the models φ₁ and φ₂ are applied in a single loop 1070 using one single test 1030.

In further aspects, the computational complexity of extracting features to facilitate classification of the reference samples into different classes (e.g., class A 510 and class B 520) can be reduced. For example, one or more classifying features can be extracted from a smaller region (e.g., a subregion of the reference area or of the CU). The features may be progressively determined while looping 945 through the reference samples to compute the autocorrelation matrices and the cross-correlation vectors 920, 930. Thus, in an aspect, a histogram can be updated based on reference samples sequentially obtained while looping 945 through the reference samples, and the one or more features can be recomputed based on the updated histogram.

For example, a single line or a single column in the reference area (e.g., regions R₁, R₂, and/or R₃) can be used to extract a threshold T (i.e., a classifying feature) that represents the average of luma samples along the single line or the single column. The threshold T may be progressively determined based on a histogram of luma samples that can be incrementally built when looping 945 through the reference samples—the histogram is updated based on reference samples sequentially obtained while looping 945 through the reference samples, and the threshold Tis recomputed based on the updated histogram. In this way, one loop 945 can be used for computing T and for computing 920, 930 the autocorrelation matrices (A₁ and A₂) and cross-correlation vectors (B₁ and B₂). Additionally, to further reduce complexity (in terms of computational speed and memory storage), one may use a quantized histogram.

As disclosed herein, the representation of the model parameters can be simplified. To that end, in an aspect, the model parameters produced 950, 960, 970 by the process of FIG. 9 can be rescaled 955, 965, 975. The CC-based prediction of a chroma sample Cₚ(i, j) can be implemented as follows:

$${C}_{p} ( i , j ) = ( ( {\sum }_{m = 1}^{M} {ϕ}_{m} \cdot {s}_{m} ) + ( 1 ≪ ( sh - 1 ) ) ) ≫ sh \qquad ( 16 )$$

where, Cₚ(i, j) is a predicted chroma sample at location (i, j), φₘ is an element of the model parameter vector φ, and sₘ is an element of the observation vector s that is formed based on luma samples associated with location (i, j) (see equations (7) or (12)), and Mis the dimension of the parameter vector φ and the observation vector s. In ECM, for example, the number of bits nc that are used to represent the model parameters, φ, is 64—that is, nc=64 and sh=16. Thus, all the operations involved in implementing equation (16) are carried out with 64 bit buffers (or registers).

In an aspect, to reduce complexity, the model parameters, φ, are rescaled 955, 965, 975 so that the rescaled parameters can be represented with a fewer bits—that is, the rescaled parameters may be stored using nd bit buffers. As a result, applying the parameter vector to predict chroma samples (operations involved in equation (16)) can be carried out using buffers at a desired maximum nb number of bits, that is lower than 64 bits. For example, one may want to limit nd to 32-bits or 16-bits signed integer so that the processor may use SIMD accelerators (such as AVX or SSE).

The value of nd can be derived from nb, the SIMD code, and sₘₐₓ, where sₘₐₓ is the maximal value of elements in the observation vector s. For example, in a case where the prediction in (16) is implemented with an iterative sum of the weighted samples, the value of nd can be determined so that the following requirements are satisfied:
a) The result of sₘₐₓφφₘ should be within the nb bit-range value for m={1, . . . M},
b) The result of

$${\sum }_{m = 1}^{n} {ϕ}_{m} \cdot {s}_{m}$$

should be within the nb bit-range value for n={1, . . . M}, and
c) The result of

$$( ( {\sum }_{m = 1}^{M} {ϕ}_{m} \cdot {s}_{m} ) + ( 1 ≪ ( sh - 1 ) ) )$$

should be within the nb bit-range value.

The above requirements may be adapted into the SIMD instruction set. For example, if applying the parameter vector to predict chroma samples is implemented as follows:

$${C}_{p} ( i , j ) = ( ( {\sum }_{m = 1}^{M / 2} {ϕ}_{2 m} \cdot {s}_{2 m} + {ϕ}_{2 m - 1} \cdot {s}_{2 m - 1} ) + ( 1 ≪ ( sh - 1 ) ) ) ≫ sh \qquad ( 17 )$$

Then the second requirement (b) is changed to:
(b) The result of

$$( {\sum }_{m = 1}^{q} {ϕ}_{2 m} \cdot {s}_{2 m} + {ϕ}_{2 m - 1} \cdot {s}_{2 m - 1} )$$

should be within the nb bit-range value for q={1, . . . M/2}.

The rescaling of the coefficients may be performed with right shifting as follows:

$${ϕ}_{m} ≫ shC or ( {ϕ}_{m} + ( 1 << ( shC - 1 ) ) ) >> shC \qquad ( 18 )$$

The value of shC should be below or equal to sh. Additionally, in equation (17) sh is replaced with (sh-shC). In an aspect, in a case where the value of shC is above sh, then default parameters can be used, for example {φₘ=0, for m=1 . . . M−1 and φ_{M}=1, sh=0}. In another aspect, in a case where the value of shC is above sh, then sh is replaced with (shC−sh) and the right shift is replaced with left shift.

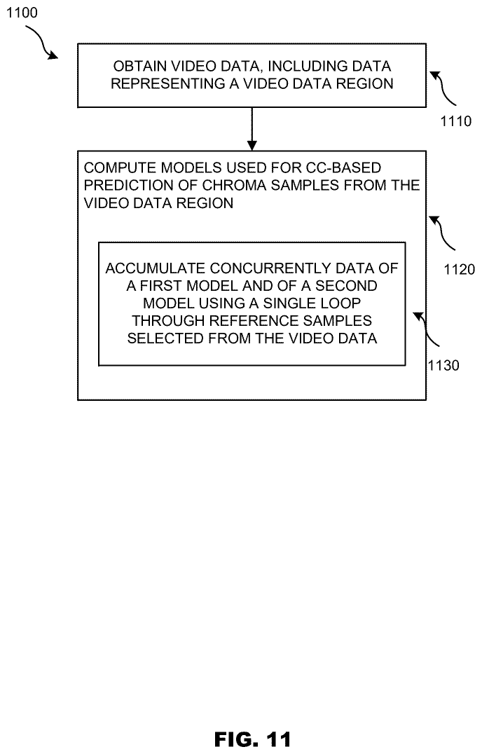

FIG. 11 is a flowchart of an example method 1100, according to which aspects of the present embodiments can be implemented. The method 1100 may be employed by an encoder 200 or a decoder 300. According to the method 1100, video data are obtained, in step 1110, that include data representing a video data region. The method computes, in step 1120, models applicable for CC-based prediction of chroma samples from the video data region. As described above, the models may be, for example, one of CCLM, CCCM, GL-CCCM, or a combination thereof. The computation of the models includes, in step 1130, the process of accumulating concurrently 920, 930 data of a first model φ₁ and data of a second model φ₂ using a single loop 945 through reference samples selected from the video data. As described above, the accumulated data of the first model can include a first auto-correlation matrix and a first cross-correlation matrix and the accumulated data of the second model can include a second auto-correlation matrix and a second cross-correlation matrix.

Furthermore, the accumulated data of the first model and of the second model are computed, in step 1130, based on the reference samples according to their respective classification into a first class or a second class. To classify the reference samples into a first class or a second class, features can be extracted, based on the reference samples, using the single loop 945 through the reference samples. In an aspect, the features can be extracted based on a subset of the reference samples. In another aspect, a histogram can be built, where the histogram is updated based on reference samples sequentially obtained while looping 945 through the reference samples, and features may be recomputed based on the updated histogram. For example, an extracted feature may be a threshold value T computed based on the reference samples.

Furthermore, the method 1100 may combine 950 accumulated data of the first model with accumulated data of the second model into combined data of a single model φ₀. In an aspect, the first model φ₁ and the second model φ₂ are used in a multi-model prediction of the chroma samples. In this case, the application of the first model and the second model can be performed with a single loop 1070 through samples of the video region; and the first model and the second model are applied 1040, 1050 to predict the chroma samples according to their classification into the first or the second class, as shown in FIG. 10. In a further aspect, the parameters of the first model φ₁, the second model φ₂, and the single model φ₀ can be rescaled into a lower bit size representation (e.g., 32 bits or 16 bits) to reduce the computational complexity involved in applying the models, as explained above.

We have described several aspects and embodiments in the present disclosure. These aspects and embodiments provide at least the following outputs and results, including all combinations, across different claim categories and types:
Encoding, into coded video data, syntax elements that can enable the decoder to decode the coded video data, according to any of the aspects described herein.
A bitstream that includes one or more of the described syntax elements, or variations thereof. A bitstream can be any set of data whether transmitted, stored, or otherwise made available.
Creating, transmitting, receiving, and/or decoding of the bitstream.
An electronic device (e.g., a TV, a set-top box, a cell phone, or a tablet) that tunes (e.g., using a tuner) a channel to receive the bitstream or that receives (e.g., using an antenna) the bitstream over the air. The electronic device decodes the syntax elements from the bitstream, and, optionally, displays (e.g., using a monitor, screen, or any other type of display) a resulting image.

Various other generalized, as well as particularized, outputs, results, implementations, and claims are also supported and contemplated throughout this disclosure.

Various methods are described herein, and each of the methods comprises one or more steps or actions for achieving the described method. Unless a specific order of steps or actions is required for the proper operation of the method, the order and/or use of specific steps and/or actions can be modified or combined. Additionally, terms such as “first”, “second”, etc. can be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and can occur, for example, before, during, or in an overlapping time period with the second decoding.

Various methods and other aspects described in this application can be used to modify modules, for example, the modules of the video encoder 200 and the video decoder 300 as shown in FIG. 2 and FIG. 3. Moreover, the present aspects are not limited to a specific standard (such as VVC or HEVC) and can be applied, for example, to other standards and recommendations, as well as extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video data in order to produce an encoded bitstream. Additionally, the terms “reconstructed” and “decoded” can be used interchangeably, the terms “encoded” or “coded” can be used interchangeably, and the terms “image,” “picture,” and “frame” can be used interchangeably. Usually, but not necessarily, the term “reconstructed” is used on the encoder side while the term “decoded” is used on the decoder side.

Note that the syntax elements as used herein are descriptive terms. As such, they do not preclude the use of other syntax element names.

This disclosure has described various pieces of information, such as for example syntax, that can be transmitted or stored, for example. This information can be packaged or arranged in a variety of manners, including, for example, manners that are common in video standards such as putting the information into an SPS, a PPS, a NAL unit, a header (for example, a NAL unit header, or a slice header), or an SEI message. Other manners are also available, including, for example, manners common for system level or application level standards such as signaling the information into one or more of the following:
a. SDP (session description protocol), a format for describing multimedia communication sessions for the purposes of session announcement and session invitation, for example, as described in RFCs and used in conjunction with RTP (Real-time Transport Protocol) transmission.
b. DASH MPD (Media Presentation Description) Descriptors, for example, as used in DASH and transmitted over HTTP. A descriptor is associated with a Representation or collection of Representations to provide additional characteristics to the content Representation.
c. RTP header extensions, for example, as used during RTP streaming.
d. ISO Base Media File Format, for example, as used in OMAF and using boxes which are object-oriented building blocks defined by a unique type identifier and length (also known as ‘atoms’ in some specifications).
e. HLS (HTTP live Streaming) manifest transmitted over HTTP. A manifest can be associated, for example, with a version or collection of versions of content to provide the characteristics of the version or collection of versions.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (PDAs), and other devices that facilitate communication of information between end-users.

Reference to “one/an aspect” or “one/an embodiment” or “one/an implementation,” as well as other variations thereof, means that a particular feature, structure, characteristic, and so forth described in connection with the aspect/embodiment/implementation is included in at least one embodiment. Thus, the appearances of the phrase “in one/an aspect” or “in one/an embodiment” or “in one/an implementation,” as well any other variations, appearing in various places throughout this application, are not necessarily all referring to the same embodiment.

Additionally, this application can refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing,” intended to be a broad term. Receiving the information can include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B,” is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization parameter for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual data, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

1. A method comprising:
obtaining video data, including data representing a video data region; and
computing models, used for cross-component based prediction of chroma samples from the video data region, the computing comprises:
accumulating concurrently data of a first model and of a second model using a first loop through reference samples selected from the video data.

2. The method according to claim 1, further comprising:
rescaling at least one parameter of the first model and the second model, wherein the rescaling includes rescaling the parameter into a lower bit size representation.

3. The method according to claim 1, further comprising:
applying the first model and the second model using a second loop through samples of the video region, wherein the first model and the second model are applied to predict the chroma samples according to their classification into a first class or a second class.

4. The method according to claim 1, further comprising:
combining the accumulated data of the first model and of the second model into a combined data of a single model.

5. The method according to claim 4, further comprising:
rescaling at least one parameter of the single model, wherein the rescaling includes rescaling the parameter into a lower bit size representation.

6. The method according to claim 1, wherein the accumulated data of the first model and of the second model are generated based on the reference samples according to their respective classification into a first class and a second class.

7. The method according to claim 6, further comprising:
extracting, based on the reference samples, one or more features, used for the classification of the reference samples into the first class and the second class, using the first loop through the reference samples.

8. The method according to claim 7, wherein the extracted one or more features are extracted based on a subset of the reference samples.

9. The method according to claim 7, wherein the extracting of the one or more features comprises:
updating a histogram based on reference samples sequentially obtained while looping through the reference samples in the first loop, and
recomputing, based on the updated histogram, the one or more features.

10. The method according to claim 7, wherein the one or more features include a threshold value computed based on the reference samples.

11. The method according to claim 1, wherein the accumulated data of the first model include a first auto-correlation matrix and a first cross-correlation vector, and wherein the accumulated data of the second model include a second auto-correlation matrix and a second cross-correlation vector.

12. The method according to claim 1, wherein the models are one of a cross-component linear model (CCLM), a convolutional cross-component model (CCCM), a gradient and location based convolutional cross-component model (GL-CCCM), or a combination thereof.

13. The method according to claim 1, wherein the method is performed by a video encoder.

14. The method according to claim 1, wherein the method is performed by a video decoder.

15. An apparatus, comprising:
at least one processor; and
memory storing instructions that, when executed by the at least one processor, cause the apparatus to:
obtain video data, including data representing a video data region, and
compute models, used for cross-component based prediction of chroma samples from the video data region, the computing comprises:
accumulating concurrently data of a first model and of a second model using a first loop through reference samples selected from the video data.

16. The apparatus according to claim 15, wherein the instructions further cause the system to:
rescale at least one parameter of the first model and the second model, wherein the rescaling includes rescaling the parameter into a lower bit size representation.

17. The apparatus according to claim 15, wherein the instructions further cause the system to:
apply the first model and the second model using a second loop through samples of the video region, wherein the first model and the second model are applied to predict the chroma samples according to their classification into a first class or a second class.

18. The apparatus according to claim 15, wherein the instructions further cause the system to:
combine the accumulated data of the first model and of the second model into a combined data of a single model.

19. The apparatus according to claim 18, wherein the instructions further cause the system to:
rescale at least one parameter of the single model, wherein the rescaling includes rescaling the parameter into a lower bit size representation.

20. The apparatus according to claim 15, wherein the accumulated data of the first model and of the second model are generated based on the reference samples according to their respective classification into a first class and a second class.

21-25. (canceled)
